(19) United States
(12) Patent Application Publication
(10) Pub. No.: US 2021/0379912 A1
(43) Pub. Date: Dec. 9, 2021

(54) CUTTER ASSEMBLY AND PRINTER

(71) Applicant: HEWLETT-PACKARD DEVELOPMENT COMPANY, L.P., Spring, TX (US)

(72) Inventors: Felix RUIZ MARTINEZ, Sant Cugat del Valles (ES); Martin URRUTIA NEBREDA, Sant Cugat del Valles (ES); Francisco Javier POZUELO LOPEZ, Sant Cugat del Valles (ES); Inigo Benjamin ORAA GIL, Sant Cugat del Valles (ES)

(21) Appl. No.: 17/049,523

(22) PCT Filed: Aug. 30, 2018
(86) PCT No.: PCT/US2018/048681

§ 371 Date: Oct. 21, 2020

(51) Int. Cl. B41J 11/70; B26D 1/24; B26D 1/18; B26D 7/26

(52) U.S. Cl. CPC B41J 11/706; B26D 7/2621; B26D 1/185; B26D 1/245

(57) ABSTRACT

A cutter assembly for a printer includes a cutter module including a rotary cutting blade and a gear associated with the rotary cutting blade, wherein rotation of the gear is transmitted to the rotary cutting blade to drive the rotary cutting blade, a toothed belt extending along a cutting direction and arranged to engage with the gear; and a support component extending along the cutting direction and comprising a ledge to support and guide the toothed belt.

### BACKGROUND

Some printers include a cutter assembly which can cut a print medium before or after a printing operation. The cutter assembly may include a cutter module having a cutting blade supported on a carriage to move across a print zone. By movement of the carriage across the print zone and/or movement of the print medium along a media advance path through the print zone, the cutter module may cut in one or two linear directions, such as the X and Y directions.

### BRIEF DESCRIPTION OF DRAWINGS

The following description references the drawings, wherein

FIG. 1 is a schematic perspective overview of a cutter assembly, according to an example;

FIG. 2 is a schematic perspective view of a part of a cutter assembly, showing a cutter module at a left-hand side of the assembly, according to an example, with parts broken away;

FIG. 3 is a sectional view of the part of the cutter assembly of FIG. 1 as seen from the right-hand side in FIGS. 1 and 2, according to an example;

FIG. 4 is a perspective view of part of a cutter assembly, showing the cutter module at the left-hand side of the assembly, according to an example;

FIG. 5 is a perspective view of another part of a cutter assembly, showing the cutter module at the right-hand side of the assembly, according to an example;

FIG. 6 is a schematic perspective view of part of a cutter assembly from below, showing the cutter module at the left-hand side of the assembly, with parts broken away, according to an example;

FIG. 7 is a schematic perspective view of part of a cutter assembly from below, showing the cutter module at the right-hand side of the assembly, with parts broken away, according to an example;

FIG. 8 is a detailed view of an upper rotary cutting blade and a lower rotary cutting blade of the cutter assembly as seen from above, according to an example;

FIG. 9 is another detailed view of one of the rotary cutting blades according to an example;

FIG. 10 is a flow diagram of a cutting process according to an example

### DETAILED DESCRIPTION

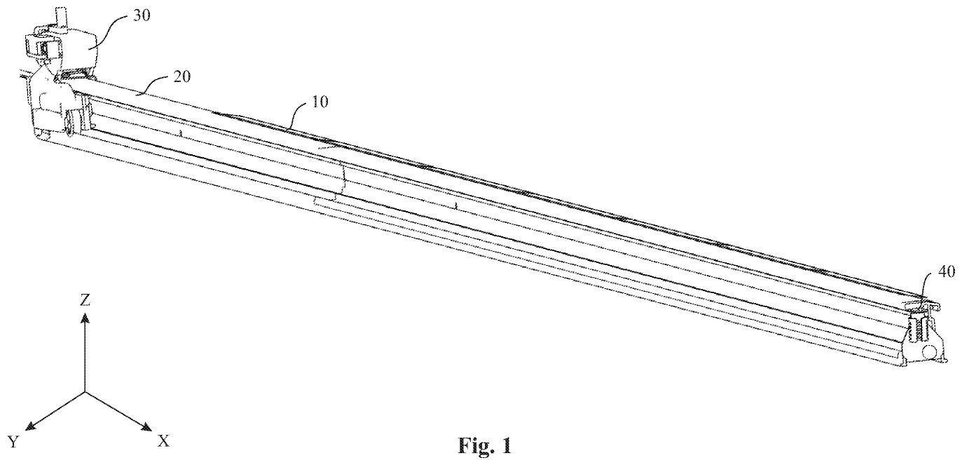

FIG. 1 provides an overview of a cutter assembly according to an example. In this example, the cutter assembly is provided in a printer, such as a large format printer which prints on a continuous web of a print medium, such as a continuous web of paper, carton, foil, glossy and coated material, backlighting material, or textile, including thick and/or rigid printing media, such as canvas having a thickness of 0.2 to 0.4 mm, for example. The print medium also may be provided as single sheets that are fed from an input tray or a drawer, or a roll of any of the above materials, for example. The printer may be an inkjet printer or another type of printer, including but not limited to a scanning printer which comprises a printer carriage (not shown) which carries one or several print heads. The printer carriage may scan across a print zone, schematically shown by a number of print platens 10, in a scanning direction and the print head(s) may deposit a printing fluid on the print medium, when the print medium is transported through the print zone in a print media advance direction. For example, one replaceable ink jet print head or four, MCYK, ink inkjet print heads may be provided in the carriage. A printing fluid may be dispensed from the print heads which may be any fluid that can be dispensed by an inkjet-type printer or other inkjet-type dispenser and may include inks, varnishes, and/or post or pre-treatment agents, for example.

A print zone may be defined as the entire area or part of the area which can be traversed by the carriage. The scanning direction of the carriage also may be designated as X direction, the print media advance direction also may be designated as Y direction, and the direction of gravity also may be designated as Z direction. In the context of this application, a front view of the printer and of cutter assembly corresponds to a view in the X-Z plane, and a side view corresponds to a view in the Y-Z plane. A top view corresponds to a view in the X-Y plane. Directions, such as up and down, above and below, or right and left are defined as shown in the drawings.

FIG. 1 schematically shows a cutter assembly including a support component 20, extending along a cutting direction which is aligned to the scanning direction X of the printer carriage (not shown). In a printer, the carriage can move along a slide bar. A cutter module 30 can be engaged with the printer carriage to move along the support component 20 by it following movement of the carriage. The support component 20 is located below the print zone, schematically illustrated by platen 10. The cutter module 30 is located partially above and partially below the print zone, as described in further detail below. For example, the cutter module includes a rotary cutting blade and a gear associated with the rotary cutting blade, wherein rotation of the gear is transmitted to the rotary cutting blade to drive the rotary cutting blade. The assembly further comprises a toothed belt 40 which extends along the support component 20 in the cutting direction X and which is arranged to engage with the gear. A distal end of the belt 40 may be recognized that the right-hand side of FIG. 1 wherein this end of the belt may be fixed to the support component, as explained further below. The support component 20 also supports and guides the toothed belt 40, in the following also simply referred to as the belt.

In operation, a print medium may be transported through the print zone above platen 10 where a print fluid is to be deposited on the print medium. The printer may further comprise a print medium advance system to transport the print medium through the print zone in the media advance direction Y. The print media advance system may comprise media transport rollers, for example. Further, if the print medium is to be cut in a direction orthogonal to the print media advance direction, the cutter module 30 can be engaged with the carriage and the carriage can be moved in the scanning direction X, with the cutter module following movement of the carriage along the support component. During movement of the cutter module 30 along the support component 20, the gear engages with the belt 40 to rotate the gear wherein rotation of the gear is transmitted to the rotary cutting blade to rotate the blade to cut the print medium. During movement of the cutter module 30, the support component 20 supports and guides both the cutter module 30 and the belt 40. Further, during movement of the cutter module 30, the cutter assembly may bias the gear against the belt 40 to ensure rotation of the rotary cutting blade and avoid slippage even if cutting thick print media, such as canvas.

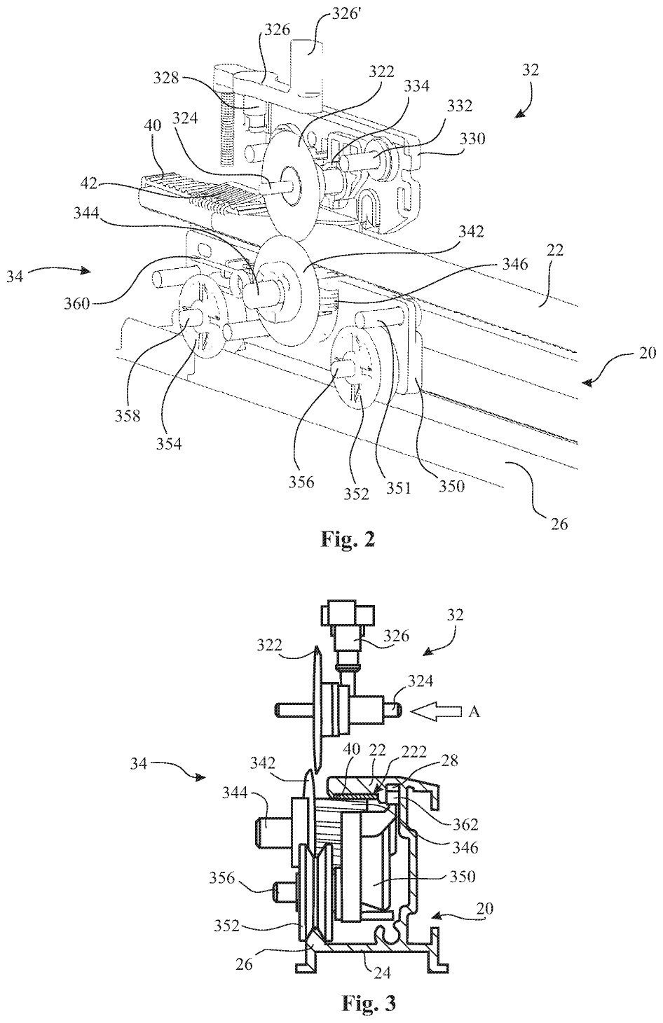

Further details of an example of a cutter assembly including a cutter module 30 are described with reference to FIGS. 2 and 3. These and the other drawings may relate to the same example or to different examples, i.e. features shown in the drawings may be combined in any useful way and the illustrated features can be but do not have to be present in combination. Other combinations of features than shown can be implemented. Except as defined in the independent claims, features may be exchanged, replaced or omitted.

In FIGS. 2 and 3, the cutter module 30 is schematically illustrated as including an upper module half 32 and a lower module half 34.

The upper module half 32 includes an upper rotary cutting blade 322 supported on an upper shaft 324 and a coupler 326 for removably engaging the cutter module 30 with a carriage (not shown). The coupler 326, in combination with the carriage (not shown) can be designed in such a way that the carriage can “pick up” the cutter module 30 when the cutting process is to be performed. The cutter module may be parked at one side of the printer, i.e. to the left or to the right of the support component. When a medium should be cut, a pickup mechanism including the coupler 326 may allow the printer carriage to pick up and release the cutter module, moving the carriage to respective position along the scan axis, or X axis, of the carriage movement. The coupler 326, for example, may include a connecting pin 328 which can be moved into and out of engagement with the cutter module to couple and decouple the cutter module 30 to/from the carriage. The coupler 326 can be operated manually or automatically, e.g. by a user manipulating a handle 326′ of the coupler 326.

The upper module half 32 further includes a base or frame 330, connecting pins 332 for a housing component and a bearing 334 for rotatably supporting the upper rotary cutting blade 322. A housing component and further structural components may be provided but, in in at least some of the figures, have been omitted to more clearly illustrate operating features of the cutter module 30.

The lower module half 34 includes a lower rotary cutting blade 342 supported on a lower shaft 344 and a gear 346 which may be coaxially aligned with and attached to rotate with the lower rotary cutting blade 342. The gear 346 may be attached to or integrated with the lower shaft 344. The gear may be helical gear or another toothed gear and, in the following, is referred to as the gear. The lower module half 34 further includes a lower base 35o for supporting the lower rotary cutting blade 342 via the lower shaft 344. In this example, the lower base 34o also supports two guide wheels 352, 354 on respective shafts 356, 358. In FIG. 3, guide wheel 354 is hidden behind guide wheel 352. The lower module half 34 may further include connecting pins 351 for a housing component and a bearing for rotatably supporting the lower rotary cutting blade 342 and the gear 346. A housing component and some of the above and further structural components, in at least some of the figures, have been omitted to more clearly illustrate operating features of the cutter module 30.

In a different configuration, the gear 346 may not be coaxially aligned to the lower rotary cutting blade 342 but is coupled to the lower rotary cutting blade 342 via transmission, which may include at least one additional transmission gear (not shown).

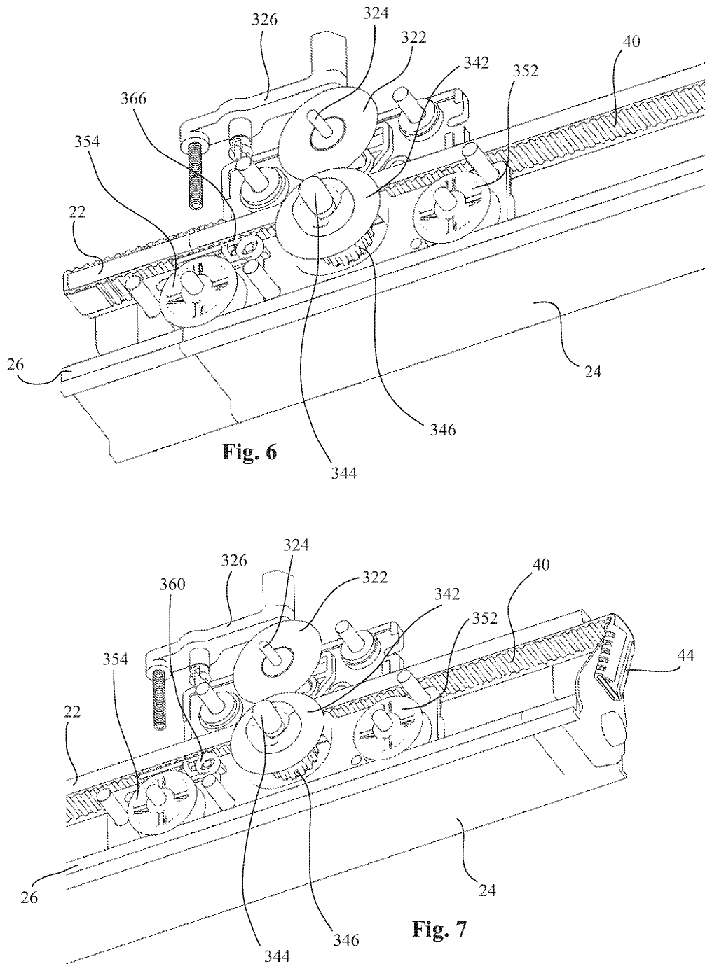

The cutter assembly further comprises a belt 40 extending in the cutting direction X and being arranged so that the teeth of the belt 40 are facing the gear 346 to engage with the gear 346. This is further illustrated in FIGS. 6 and 7. In the example of FIG. 2, one end of the belt 40 is attached to an upper surface of the upper support ledge 22 via a clamping element 42, such as a clamping spring or another clamping device. This may be a rigid connection between the belt and the supporting component. The belt 40 may be made of or include material having some elasticity, such as including either of or a combination of some of silicon rubber, polyurethane, nylon and Aramide fibers. The belt 40 may have a stretch or extension ratio of about 102% to 110% at room temperature.

The cutter assembly further comprises the support component 20 extending along the scanning/cutting direction X, an example of which is illustrated in FIGS. 2 and 3. In this example, the support component 20 includes an extruded or otherwise manufactured elongated profile, extending in the cutting direction X, to guide and support the cutter module 30 and the belt 40, described in further detail below. The profile can be made of metal, such as aluminum or aluminum alloy, or plastic or a combination thereof. It can be manufactured by extrusion and/or machining, for example.

In this example, the profile of the support component 20 comprises an upper support ledge 22 which provides a counter surface to support the back side of the belt 40, prevents the belt from moving in the media advance direction, and provides a support for tensioning the belt, as explained in further detail below. The upper support ledge 22 may include a depression 222 or other geometry to receive the belt 40 and to counter movement of the belt in a direction other than the cutting direction X. The support component 20, in particular the upper support ledge 22, further may be designed to attach opposite ends of the belt 40, as explained below.

The profile further comprises a lower support ledge 24, featuring a guide rail 26 for supporting, stabilizing and guiding the cutter module 30. The upper ledge 22 and the lower ledge 24 are connected by a bridge portion 26 of the support component 20. In the example illustrated in FIG. 3, a groove 28, extending along the length of the support component 20, is formed at the interface of the upper support ledge 22 and the bridge portion 26. The groove 28 may serve to guide and stabilize the lower base 350, with a slider 362 attached to or integrated with the base 350 in engagement with the groove 28 when the cutter module 30 is mounted on the support component 20. Instead of a groove-slider combination, alternative means for guiding and stabilizing the cutter module moving along the support component may be provided.

The upper and lower support ledges 22, 24, which may be combined with guiding and stabilizing features, support and guide the cutter module 30 wherein the cutter module 30 is movable along the guide rail 26 in the cutting direction. The upper and lower support ledges 22, 24 further allow biasing the gear 346 against the front side of the belt 40.

To bias the gear 346 against the front side of the belt 40, i.e., the cutter module 30 may comprise biasing component, such as a spring 360, which, in this example, pushes the gear 346 upwards, using one of the guide wheels 354 as a counter surface, as illustrated in FIG. 7. The biasing component, such as spring 360, hence biases the gear 346 upwards and against the belt 40, so that the teeth of the gear 346 are and stay engaged with the teeth of the belt 40 during an entire cutting process.

To cut a print medium in the cutting direction X, the cutter module 30 is supported by and moved along the support component 20, e.g. by engaging the cutter module 30 with carriage of a printer or a dedicated carriage so that the cutter module 30 follows movement of the carriage, wherein the gear 346 is biased against the belt 40 and engages with the teeth of the belt 40. Accordingly, the gear 346 revolves along the belt 40 wherein rotation of the gear 346 is transmitted to the lower rotary cutting blade 342. The engagement between the toothed belt 40 and the gear 346 forces the lower rotary cutting blade 342 to rotate, achieving impressive cutting capabilities.

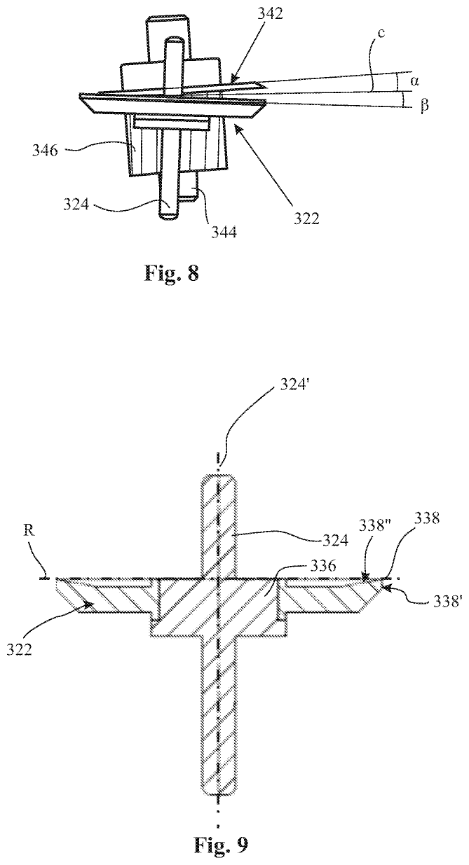

Rotation of the lower rotary cutting blade 342 can be transmitted to the upper rotary cutting blade 322 by friction when the upper and lower rotary cutting blades 322, 342 contact each other along a cutting line. To enhance contact between the upper rotary cutting blade 322 and the lower rotary cutting blade 342, the upper rotary cutting blade 322 may be biased towards the lower rotary cutting blade 342 by applying a biasing force in the direction of arrow A illustrated in FIG. 3. The biasing force may be generated by a spring device (not shown) associated with and acting on the shaft 324. Additionally, the upper rotary cutting blade 322 and the lower rotary cutting blade 342 may be tilted relative to each other at a small angle, further control the contact between the two blades. This is explained in further detail with reference to FIG. 8, below.

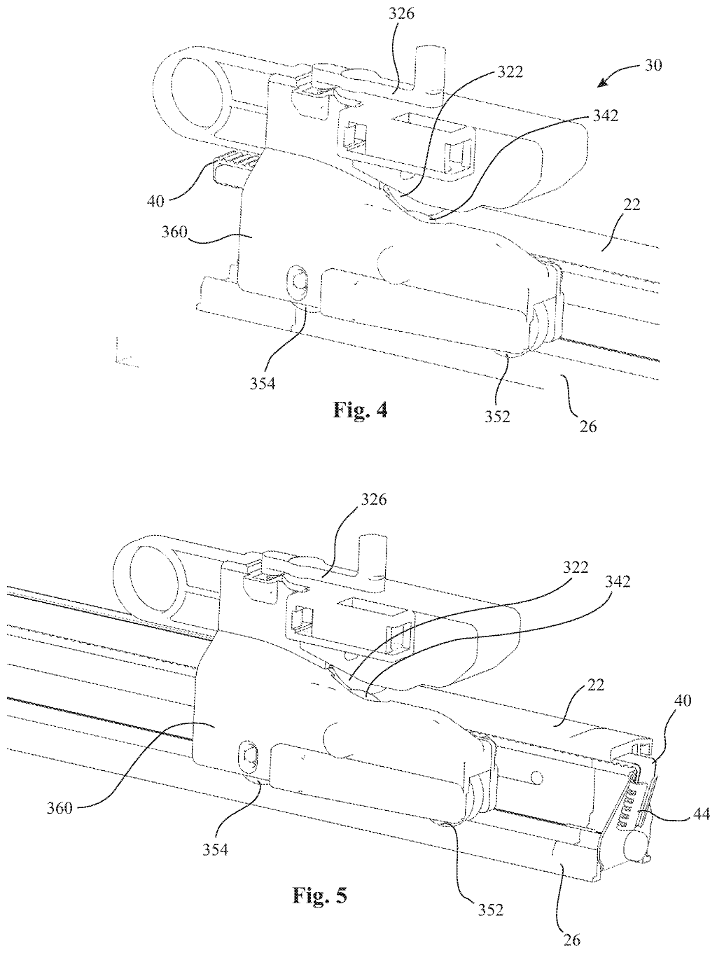

FIGS. 4 to 7 illustrate an example of a cutter module 30 which can be located at a left-hand side (FIGS. 4 and 6) and at a right hand side (FIGS. 5 and 7) of the support component 20, respectively, when looking at the cutter assembly in a direction opposite to the print media advance direction Y. The same reference numbers are used to designate the same or corresponding components as in the previous drawings. Reference is made to the above description of FIGS. 1 to 3. For the sake of clarity, some of the reference numbers have been omitted.

In addition to the previous drawings, FIGS. 4 and 5 illustrate a housing component 360 of the cutter module 30, enclosing both the upper and lower module halves. The drawings further illustrate the coupler 326 extending from a top surface of the housing component 360, and the guide wheels 352, 354 supported by the guide rail 26 to support and guide the cutter module 30 between the upper and lower ledges of the support component 20. Moreover, FIG. 4 illustrates that one end of the belt 40 is attached at the respective end face of the upper ledge 22, and FIG. 5 illustrates the opposite end of the belt 42 which is attached to the respective opposite end face of upper ledge 22 of the support component.

In the example of FIG. 5, a further clamping spring 44 is provided at the respective end face of the upper ledge 22, wherein the end of the belt 40 can be engaged with the clamping spring 44 to fix and bias the belt 40 along the length of the upper ledge 22 of the support component 20. The clamping spring 44 is elastic and allows tensioning the belt 40 to enhance nonslip traction between the belt 40 and gear 346. Tensioning of the belt 40 also allows for compensating variations of length in the supporting component 20 and/or the belt 40 due to temperature changes and aging. Accordingly, the belt always can be kept at a desired tension.

As illustrated in FIGS. 4 and 5, the cutting blades 322, 342 in the cutter module 30 of this example are not exposed to a user and can be used safely. The belt 40 is tensioned and guided within the profile of the support component 22 to engage with the gear 346 to drive the lower rotary cutting blade 342 when the cutter module 30 moves along the support component 20.

FIGS. 6 and 7 show the cutter module 30 at the left-hand side and at the right-hand side of the support component 20, in a perspective view from below, to illustrate the engagement of the gear 346 with the belt 40. The same or corresponding components as in the previous drawings are designated by the same reference numbers. Reference is made to the description of FIGS. 1 to 5. Some of the reference numbers have been omitted for the sake of clarity. FIGS. 6 and 7 particularly show how the gear 346 is arranged relative to the belt 40 wherein the spring 360 biases the gear 346 towards the belt 40 for engagement of the two. With regard to additional features shown in FIGS. 6 and 7, reference is made to the description of FIGS. 2 and 3.

In one or several examples, the lower rotary cutting blade 342 and the upper rotary cutting blade 322 may be arranged to be skewed relative to each other and relative to a cutting plane C by a few degrees to control a contact point between the two cutting blades. A skew of the lower rotary cutting blade 342 relative to the cutting plane C, implies that the rotary axis of its shaft 344 is arranged at an angle α relative to the cutting plane C. In one or several examples, the angle α may be of about 2° to 4° or about 3°, or about 4°. This may be achieved by designing the gear 346 as a helical gear wherein the belt 40 may be designed to have parallel teeth. An example of such a configuration is shown in FIG. 8.

FIG. 8 illustrates the helical gear 346 associated with the lower rotary cutting blade 342, having a skew of its teeth of a few degrees relative to the rotary axis of the shaft 344. This skew of the helical gear 346 has the effect that, when the helical gear 346 revolves along the belt 40 having parallel teeth, the rotary cutting blade 342 will be inclined at an angle α of said few degrees relative to the cutting plane C. Whereas the drawing shows an angle α of about 4°, a different angle of may be chosen.

To obtain a skew of the upper rotary cutting blade 322 relative to the cutting plane C, the rotary axis of its shaft 324 may be supported in the base 330 at an angle β relative to the cutting plane C. In one or several examples, the angle β is of about 1° to 2° or about 2°. Whereas the drawing shows an angle β of about 2°, a different angle may be chosen. Accordingly, the sum of the two angles α and β may be in the range of about 4° to 6°.

The cutting plane C may be defined as a plane in the X-Z direction in which the upper and lower rotary cutting blades 322, 342 contact each other to define a cutting point. Skewing one or both of the upper and lower rotary cutting blades 322, 342 helps controlling a defined actual cutting point between the two blades. A defined contact between the upper and lower cutting blades allows controlling a defined cutting position and makes sure that there is good friction contact between the two blades so that rotation of the lower rotary cutting blade is transmitted reliably to the upper rotary cutting blade. Using the described configuration, in one example, one turn of the lower rotary cutting blade 342 may cause at least 0.55 turns of the upper rotary cutting blade 322.

One or both cutting blades 322, 342 further may have a modified geometry to obtain sharpened cutting edges, as illustrated in FIG. 9.

In the example of FIG. 9, the upper rotary cutting blade 322 is illustrated wherein the same or similar configuration may be applied to both the upper rotary cutting blade 322 and the lower rotary cutting blade 342. The rotary cutting blade 322 is attached to a hub 336 which is attached to or integrated with the shaft 324 to rotate around rotation axis 324′ of the rotary cutting blade 322. The rotary cutting blade 322 as such may consist of or include steel. The rotary cutting blade 322 generally extends along the cutting plane C, for a rotary cutting blade without skew, or along a reference plane R which is inclined relative to the cutting plane C, as explained above with reference to FIG. 8. In the following, the rotary cutting blade 322 is discussed in regard to a reference plane R, as illustrated in FIG. 9.

The rotary cutting blade 322 of this example includes a circumferential cutting edge 338 which is defined by opposite circumferential surfaces 338′, 338″. In this example, both circumferential surfaces 338′, 338″ are inclined relative to the reference plane R and define an acute angle between them. Further, an acute angle is also defined at least between the circumferential surface 338″, which is adjacent to the reference plane, and the reference plane R. The same or a similar configuration of the rotary cutting blade 322 and/or the rotary cutting blade 342, having sharpened cutting edges may be used to optimize the cutting performance.

The cutter assembly and method achieve high quality cutting results, generating clean cut edges of high accuracy, straightness and repeatability even if cutting thick and rigid media, such as canvas having a thickness of up to 0.4 mm or more. The cutter assembly can be integrated in a printer to cut online, with no need for “empty” margins to cut the print medium to desired size and with no need to manually handle and/or transport a print medium to a separate entity for cutting. Waste of print media is avoided or minimized. As the cutter module can be engaged with a printer carriage, it does not need its own drive system but it can be a fully passive device wherein rotation of the cutting blade is caused by the printer carriage dragging along the cutter module so that the gear revolves along the belt. When not needed, the cutter module can be disengaged from the printer carriage and can be parked e.g. at a servicing station or at another location in the printer where it does not interfere with a printing process. Moreover, the cutter module is easily replaceable, e.g. if one of the cutting blades is worn out or damaged. Additional investment and space requirements are low because the cutter module can make use of the drive system of a printer carriage.

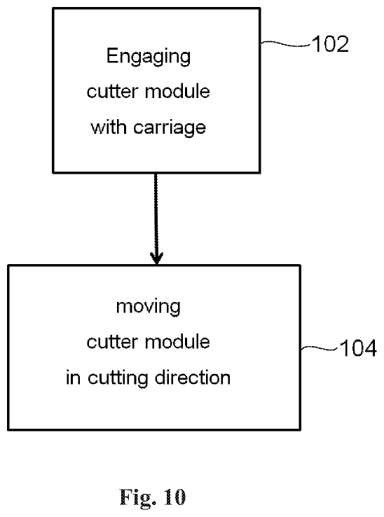

A cutting process according to an example is illustrated in FIG. 10. The cutting process uses a support component extending in a cutting direction, a toothed belt extending along the support component, and a cutter module including a rotary cutting blade and a gear coupled to the rotary cutting blade. The cutting process may use a cutter assembly as described above with reference to the drawings. At 102, the cutter module is engaged with the carriage; and at 104, the cutter module is moved along the support component wherein the gear engages with the toothed belt to rotate the gear and transmit rotation of the gear to the rotary cutting blade. Movement of the cutter module can be controlled by driving the carriage to move in a scanning direction. During movement of the cutter module, the support component supports and guides the toothed belt and the cutter module and the cutter module biases the gear against the toothed belt.

Drive of the carriage, the media advance system and any actuator(s), e.g. for coupling the cutter module and the carriage, may be controlled by a controller (not shown). The controller can be a microcontroller, ASIC, or other control device, including control devices operating based on software or firmware, including machine readable instructions, hardware, or a combination thereof. It can include an integrated memory or communicate with an external memory or both. The same controller or separate controllers may be provided for controlling carriage movement, medium advance and any actuators. Different parts of the controller may be located internally or externally to a printer or a separate cutting device, in a concentrated or distributed environment.

In the example illustrated, the cutter module has been described to be engageable with a printer carriage for movement of the cutter module in the cutting direction. In a variant, the cutter module can be provided with its own dedicated carriage and/or it can be provided as a stand-alone device or in combination with other types of equipment.

1. A cutter assembly for a printer, the cutter assembly including
a cutter module including a rotary cutting blade and a gear associated with the rotary cutting blade, wherein rotation of the gear is transmitted to the rotary cutting blade to drive the rotary cutting blade,
a toothed belt extending along a cutting direction and arranged to engage with the gear; and
a support component extending along the cutting direction and comprising a ledge to support and guide the toothed belt.

2. The cutter assembly of claim 1, wherein the ledge is shaped to counter movement of the toothed belt in a direction other than the cutting direction.

3. The cutter assembly of claim 1, wherein an end of the toothed belt is attached to the support component via a biasing component.

4. The cutter assembly of claim 1, wherein the support component comprises a guide rail extending along the cutting direction and arranged opposite to the ledge, the guide rail to support and guide the cutter module wherein the cutter module is movable along the guide rail in the cutting direction.

5. The cutter assembly of claim 4, wherein the cutter module includes a biasing component to bias the gear against the toothed belt.

6. The cutter assembly of claim 4, wherein the cutter module includes a guide wheel to travel along the guide rail.

7. The cutter assembly of claim 1, wherein the gear is a helical gear coaxial to the rotary cutting blade.

8. The cutter assembly of claim 7, wherein the toothed belt features parallel teeth wherein an axis of the gear, when engaged with toothed belt, is inclined relative to a plane parallel to the toothed belt.

9. The cutter assembly of claim 8, wherein the axis of the gear, when engaged with toothed belt, is inclined relative to the plane by 2° to 6° or about 3°, about 4° or about 5°.

10. The cutter assembly of claim 7, wherein the rotary cutting blade is a first rotary cutting blade, and further comprising a second rotary cutting blade wherein the first and second rotary cutting blades are arranged to have rotary axes which are inclined relative to each other and to engage with each other along a defined cutting line.

11. The cutter assembly of claim 10, wherein the rotary axes of the first and second rotary cutting blades both are inclined relative to a cutting plane.

12. The cutter assembly of claim 10, wherein the first rotary cutting blade is a lower cutting blade and the second rotary cutting blade is an upper cutting blade, respectively arranged below and above a cutting plane.

13. A printer, including:
a support of a print medium in a print zone;
a print medium advance system to transport the print medium through the print zone in a media advance direction;
a carriage to receive a print head, the carriage moving across the print zone in a scanning direction, the scanning direction perpendicular to the media advance direction;
a cutter module arranged at the carriage to move with the carriage in the scanning direction, the cutter module including a rotary cutting blade and a gear associated with the rotary cutting blade, wherein rotation of the gear is transmitted to the rotary cutting blade to drive the rotary cutting blade;
a toothed belt extending along the scanning direction and arranged to engage with the gear; and
a support component extending along the scanning direction and comprising a ledge to support and guide the toothed belt and a guide rail extending along the scanning direction, the guide rail to support and guide the cutter module, wherein the ledge and the guide rail are arranged opposite to each other,
the cutter module further including a biasing component to bias the gear against the toothed belt.

14. The printer of claim 13, wherein the rotary cutting blade is a lower rotary cutting blade, the cutter module further comprising an upper rotary cutting blade wherein the lower and upper rotary cutting blades are arranged below and above cutting blade and each have rotary axes which are inclined relative to come into contact along a defined cutting line.

15. A method comprising:
providing a support component extending in a cutting direction, a toothed belt extending along the support component, and a cutter module including a rotary cutting blade and a gear coupled to the rotary cutting blade,
moving the cutter module along the support component wherein the gear engages with the toothed belt to rotate the gear and transmit rotation of the gear to the rotary cutting blade;
during movement of the cutter module, the support component supporting and guiding the toothed belt and the cutter module; and
during movement of the cutter module, the cutter module biasing the gear against the toothed belt.
